(19) United States
(12) Patent Application Publication
(10) Pub. No.: US 2009/0128762 A1
(43) Pub. Date: May 21, 2009

(54) LIQUID CRYSTAL DISPLAY DEVICE AND METHOD OF MANUFACTURING THE SAME

(75) Inventors: Yong-Kuk YUN, Hwaseong-si (KR); Young-Je CHO, Cheonan-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/249,838

(22) Filed: Oct. 10, 2008

(30) Foreign Application Priority Data
Nov. 19, 2007 (KR) 10-2007-117898

(51) Int. Cl. G02F 1/1337; H01J 9/24

(52) U.S. Cl. 349/123; 445/24

(57) ABSTRACT

A liquid crystal display device includes a first substrate, a second substrate, and a liquid crystal mixture. The first substrate includes a pixel electrode, which includes a first domain forming unit, and a first vertical alignment layer arranged on the pixel electrode. The second substrate faces the first substrate and includes a common electrode and a second vertical alignment layer arranged on the common electrode. The liquid crystal mixture is interposed between the first substrate and the second substrate and includes liquid crystal molecules, an ultraviolet-curable monomer, and an ultraviolet-curable initiator. A distance between the first substrate and the second substrate is 3.6 μm or less, and a rotational viscosity of the liquid crystal mixture is 130 mPa·s or less.

### CROSS-REFERENCE TO RELATED APPLICATION

This application claims priority from and the benefit of Korean Patent Application No. 10-2007-117898, filed on Nov. 19, 2007, which is hereby incorporated by reference for all purposes as if fully set forth herein.

### BACKGROUND OF THE INVENTION

### Field of Invention

The present invention relates to a liquid crystal display (“LCD”) device that may have an improved response time, particularly an improved falling time of liquid crystal (“LC”) molecules, and a method of manufacturing the same.

### DISCUSSION OF THE BACKGROUND

Recently, there has been a high demand for a high-performance display device that displays various kinds of information, such as images, graphics, and texts. Accordingly, the display industries have showed rapid growth.

In particular, the LCD device has been developed for years as a next generation display device because the LCD device has low power consumption, a light and thin body, and does not release harmful electromagnetic waves as compared to a cathode ray tube (“CRT”) display device. The LCD device has drawn attention as a large display device (i.e. more than 30 inches) for digital broadcasting.

The LCD device includes two substrates and a liquid crystal layer disposed between the two substrates. The alignment of liquid crystal molecules is adjusted to change the transmittance of light illuminated from a backlight toward the LCD panel. Such an LCD device has been widely used in electronic devices, such as an electronic watch, an electronic calculator, a personal computer, and a television set.

The LCD device includes various alignment modes according to the alignment of the liquid crystal molecules. Among the different modes, a vertical alignment mode has attracted attention because it provides a high contrast ratio and a wide standard viewing angle.

In an LCD device in vertical alignment mode, a pixel electrode and/or a common electrode include domain forming means, such as apertures and protrusions, to divide a display area of the pixel electrode into a plurality of domain areas, which may provide for a wide viewing angle.

When an electric field generating electrode is patterned, visibility may deteriorate due to rising blurring, tail blurring, or a ghost phenomenon. In particular, when an overshoot voltage is applied to an LCD that employs a high frequency driving scheme, such as 120 Hz driving, visibility deteriorations may accelerate.

### SUMMARY OF THE INVENTION

The present invention provides an LCD device that may have an improved response speed, which may improve light transmittance and resolve visibility deteriorations, such as a ghost phenomenon, and a method of manufacturing the same.

Additional features of the invention will be set forth in the description which follows, and in part will be apparent from the description, or may be learned by practice of the invention.

The present invention discloses an LCD device including a first substrate, a second substrate, and a liquid crystal mixture. The first substrate includes a pixel electrode, which includes a first domain forming unit, and a first vertical alignment layer arranged on the pixel electrode. The second substrate faces the first substrate and includes a common electrode and a second vertical alignment layer arranged on the common electrode. The liquid crystal mixture is interposed between the first substrate and the second substrate and includes liquid crystals, an ultraviolet-curable monomer, and an ultraviolet-curable initiator. A distance between the first substrate and the second substrate is 3.6 μm or less, and a rotational viscosity of the liquid crystal mixture is 130 mPa·s or less.

The present invention also discloses a method of manufacturing a liquid crystal display device including forming a first substrate, forming a second substrate, coupling the first substrate and the second substrate together with a distance therebetween, interposing a liquid crystal mixture between the first substrate and the second substrate, and curing the liquid crystal mixture by applying pre-tilting power to the first substrate and the second substrate and irradiating ultraviolet light to the first substrate and the second substrate. The first substrate includes a pixel electrode, which includes a first domain forming unit, and a first vertical alignment layer arranged on the pixel electrode. The second substrate faces the first substrate and includes a common electrode and a second vertical alignment layer arranged on the common electrode. The liquid crystal mixture includes liquid crystals, an ultraviolet-curable monomer, and an ultraviolet curable initiator and has rotational viscosity of 130 mPa·s or less.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a view showing an LCD device according to an exemplary embodiment of the present invention.

FIG. 2 is a cross-sectional view taken along line A-A′ of FIG. 1.

FIG. 3, FIG. 4, FIG. 5, and FIG. 6 are cross-sectional views showing a method of manufacturing an LCD device according to an exemplary embodiment of the present invention.

FIG. 7 is a plan view showing an LCD device according to another exemplary embodiment of the present invention.

FIG. 8 is a cross-sectional view taken along line B-B′ of FIG. 7.

FIG. 9 is an enlarged view showing the motion of the LC molecules of portion C of FIG. 7.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element such as a layer, film, region or substrate is referred to as being “on” or “connected to” another element, it can be directly on or directly connected to the other element, or intervening elements may also be present. In contrast, when an element is referred to as being “directly on” or “directly connected to” another element, there are no intervening elements present.

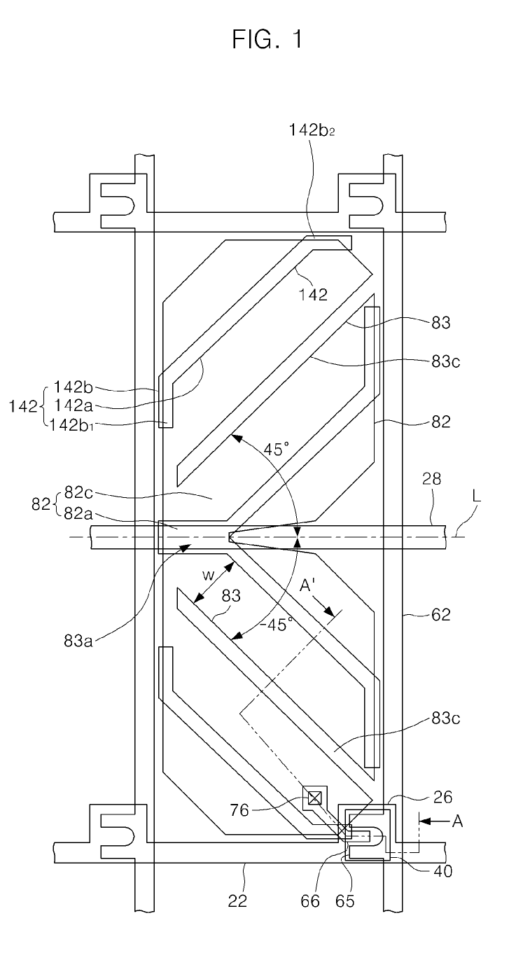

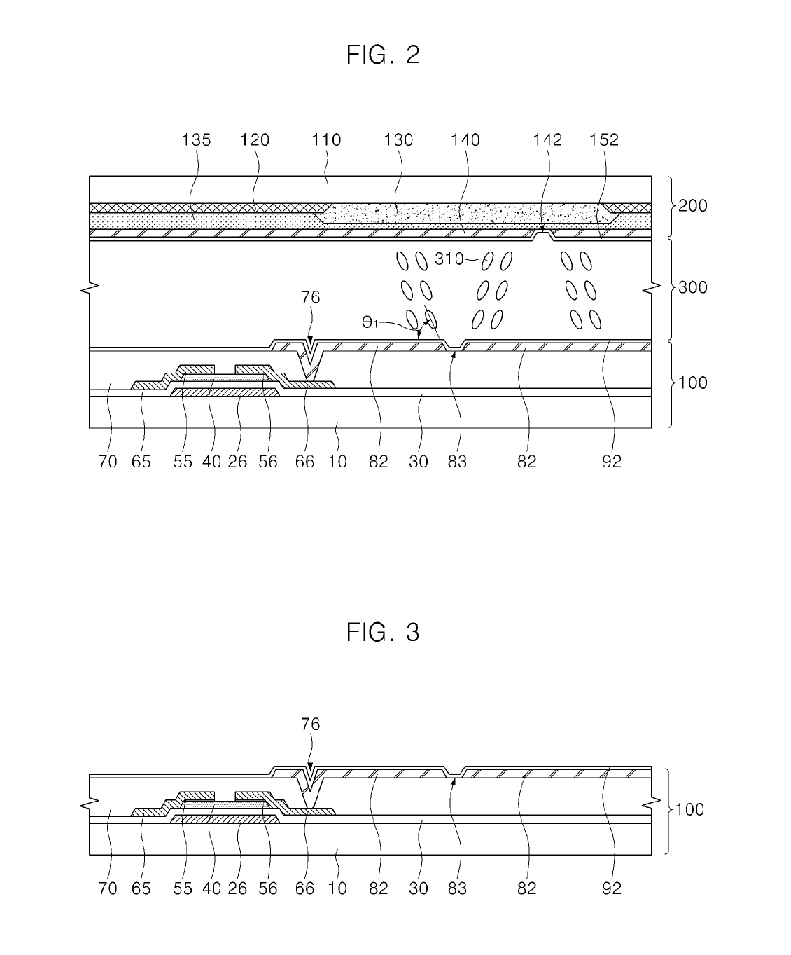

FIG. 1 is a view showing an LCD device according to an exemplary embodiment of the present invention, and FIG. 2 is a cross-sectional view taken along line A-A′ of FIG. 1.

The LCD device includes a first substrate 100, a second substrate 200 facing the first substrate 100, and an LC mixture 300 disposed between the first substrate 100 and the second substrate 200.

The first substrate 100 includes an insulation substrate 10, a pixel electrode 82 disposed on the insulation substrate 10, and various other elements, such as a first vertical alignment layer 92, which is arranged on the pixel electrode 82.

Gate wiring, which includes a gate line 22 extended in a horizontal direction, a gate electrode 26, and a storage electrode 28, is disposed on the insulation substrate 10.

A gate insulation layer 30, which may be made of silicon nitride SiNₓ or silicon oxide SiOₓ, a semiconductor layer 40, which may be made of hydrogenated amorphous silicon or polycrystalline silicon, and an ohmic contact layer 55 and 56, which may be made of n+ hydrogenated amorphous silicon doped with high-density impurities, are disposed on the gate wiring.

Data wiring, which includes a data line 62 extended vertically, a source electrode 65, and a drain electrode 66, is disposed on the ohmic contact layers 55 and 56 and the gate insulation layer 30.

A protective layer 70 is disposed on the data line 62, the drain electrode 66, and an exposed portion of the semiconductor layer 40. The protective layer 70 includes a contact hole 76 exposing the drain electrode 66.

A pixel electrode 82 is disposed on the protective layer 70 and is connected to the drain electrode 66 via the contact hole 76. The pixel electrode 82 receives a data voltage from the drain electrode 66. The pixel electrode 82 may be made of a transparent conductive material, such as indium tin oxide (“ITO”) or indium zinc oxide (“IZO”), or a reflective conductive material, such as aluminum (“Al”).

The pixel electrode 82 includes a first domain forming unit 83 to divide the pixel electrode 82 into a plurality of domain areas. In an exemplary embodiment of the present invention, the first domain forming unit 83 includes apertures formed by patterning the pixel electrode 82. The first domain forming unit 83 includes a horizontal portion 83a dividing the pixel electrode 82 into an upper portion and a lower portion and first tilt portions 83c arranged in an oblique direction at the divided upper portion and lower portion of the pixel electrode 82. The first tilt portions 83c of the upper portion are perpendicular to the first tilt portions 83c of the lower portion, so that a horizontal electric field may be uniformly dispersed in all directions. The tilt portions 83c are tilted at angles of about 45° and about −45° with respect to the gate line 22. The first domain forming unit 83 may have a substantially symmetrical structure with respect to a line L that divides the pixel area into the upper portion and the lower portion. The line L is parallel with the gate line 22. As shown in FIG. 1, the first tilt portion 83c that is substantially inclined at an angle 45° with respect to the line L (or the gate line 22) may be arranged in the upper portion of the pixel electrode 82 and the first tilt portion 83c substantially inclined at an angle of −45° with respect to the line L (or the gate line 22) may be arranged in the lower portion of the pixel electrode 82. The first domain forming unit 83 may have various shapes and arrangements as long as the first the tilt portions 83c are inclined at angles of about 45° or about −45° with respect to the gate line 22.

When using the first domain forming unit 83 of the pixel electrode 82 and a second domain forming unit 142 of a common electrode 140, which will be described below, a display area of the pixel electrode 82 is divided into a plurality of domains according to an alignment direction of the main directors of the LC molecules 310 included in the LC mixture 300 when an electric field is applied to the LC mixture 300.

A horizontal distance W between the domain forming unit 83 of the pixel electrode 82 and the second domain forming unit 142 of the common electrode 140 may be about 23 μm to about 70 μm. Since the LCD device has a long horizontal distance W, the light transmittance of the LCD device may be improved. A random motion of the LC molecules 310, which may be caused by the long horizontal distance W, may be prevented by pre-tilting the LC molecules 310 with ultraviolet (“UV”) radiation.

A first vertical alignment layer 92 is disposed on the pixel electrode 82 and the protective layer 70 to align the LC molecules 310. The first vertical alignment layer 92 vertically aligns the LC molecules 310 together with a second vertical alignment layer 152, which will be described below with reference to FIG. 2. Therefore, when a driving voltage is not applied to the LCD device, the LCD device displays black. The first vertical alignment layer 92 may be made of a material including a main chain of polyimide and a side chain.

The second substrate 200 includes various elements, such as the common electrode 140 disposed on the insulation substrate 110 and the second vertical alignment layer 152 disposed on the common electrode 140, and the second substrate 200 faces the first substrate 100.

A black matrix 120 is disposed on the insulation substrate 110 to prevent light leakage and to define the pixel area. Red, green, and blue color filters 130 are sequentially arranged in the pixel area between black matrixes 120. An overcoat layer 135 may be disposed on the color filters 130 to planarize surfaces of the black matrix 120 and the color filters 130. The common electrode 140 may include transparent material, such as ITO or IZO, and is disposed on the overcoat layer 135.

The common electrode 140 is divided into the plurality of domain areas by the second domain forming unit 142. The second domain forming unit 142 may be a pattern formed by patterning the common electrode 140, for example, an aperture formed in the common electrode 140. The second domain forming unit 142 includes second tilt portions 142a alternately arranged and parallel with the first tilt portions 83a of the first domain forming means 83, and end portions 142b overlapping edges of the pixel electrode 82. The end portions 142b of the second domain forming unit 142 include vertical end portions 142b₁ and horizontal end portions 142b₂.

The first tilt portions 83a and the second tilt portions 142a may be arranged parallel with each other in the same direction. The first tilt portions 83a and the second tilt portions 142a are alternately arranged with each other to form fringe fields. Although a case in which the first domain forming unit 82 and the second domain forming unit 142 include apertures has been explained, the first domain forming unit 82 and the second domain forming unit 142 may include other shapes, such as protrusions.

A second vertical alignment layer 152 is disposed on the common electrode 140 to vertically align the LC molecules 310. The second vertical alignment layer 152 may be made of the same material as the first vertical alignment layer 92. The LCD device having the first vertical alignment layer 92 and the second vertical alignment layer 152 may easily display a black color in an initial state where the driving voltage is not applied to the LCD device. Also, the LCD device having the first vertical alignment layer 92 and the second vertical alignment layer 152 may have decreased UV monomer content, which may improve the reliability of the LCD device.

The LC mixture 300, which is made of a UV-curable monomer, a UV-curable initiator, and LC molecules 310, is interposed between the first substrate 100 and the second substrate 200.

The LC molecules 310 included in the LC mixture 300 may have negative dielectric constant anisotropy. For example, the LC molecules 310 may be nematic LC molecules. The UV-curable monomer may be an acrylate-based monomer and the UV-curable initiator may be made of materials that can absorb UV light, such as 2,2-dimethoxy-1, and 2-diphenyl ethanone.

The UV-curable initiator content of the LC mixture 300 may be over 0% by weight and less than 0.05% by weight based on the LC molecules 310, and more specifically, may be over 0.025% by weight and less than 0.05% by weight. The UV-curable monomer content of the LC mixture 300 may be over 0% by weight and less than 10% by weight based on the LC molecules 310, and more specifically, may be over 0% by weight and less than 0.05% by weight. When the contents of the UV-curable initiator and the UV-curable monomer are below the above ranges, the luminance of the LCD device may decrease. When the contents of the UV-curable initiator and the UV-curable monomer are above the above ranges, the reliability of the LCD device may decrease.

The LC molecules 310 included in the LC mixture 300 are pre-tilted at an angle of about 88° to about 90°, more specifically about 88.5° to about 90°, with respect to the first substrate 100 with UV radiation, when the driving voltage is not applied to the first substrate 100 and the second substrate 200. Accordingly, the response speed of the LC molecules 310 is improved, since the LC molecules 310 interposed between the pixel electrode 82 and the common electrode 140 are tilted by the driving voltage without going through a random motion. Generally, the response speed of the LCD device of a patterned vertical alignment (“PVA”) mode decreases because the random motion is increased as the driving voltage for the LCD device of the PVA mode is increased. However, in the LCD device according to an exemplary embodiment of the present invention, although the driving voltage is increased to improve the transmittance of the light, the response speed does not decrease because the random motion is prevented by pre-tilting the LC molecules 310.

Rotational viscosity of the LC mixture 300 is adjusted to be 130 mPa·s or less. When the overshoot voltage, such as dynamic capacitance compensation (“DCC”), is applied for high frequency driving, such as 120 Hz driving, visibility deteriorations, such as rising blurring and the ghost phenomenon, may occur. The ghost phenomenon, which is most easily noticed out of the visibility deteriorations, may be caused by an increased falling time of the response time of the LC molecules 310. However, the visibility deteriorations, including the ghost phenomenon, may be decreased by adjusting the rotational viscosity of the LC mixture 300 to the above range, for example, by pre-tilting the LC molecules 310, to decrease the falling time of the LC molecules 310. A method of adjusting the rotational viscosity of the LC mixture 300 is not specially limited and any other methods using low-viscosity LC molecules may be available.

The refractive index anisotropy of the LC mixture 300 may be adjusted in a range of from 0.085 to 0.15, but the refractive index anisotropy is not limited to this range.

The distance between the first substrate 100 and the second substrate 200 may be adjusted to be 3.6 μm or less. The falling time may be decreased by adjusting the distance between the first substrate 100 and the second substrate 200 to the above range, which may reduce visibility deteriorations, such as the ghost phenomenon.

A polarizer may be arranged on sides of each of the first substrate 100 and the second substrate 200 that are opposite sides on which a plurality of elements are arranged.

A back light assembly, which includes a lamp, is arranged below an LCD panel including the first substrate 100, the second substrate 200, and the LC mixture 300 between the first substrate 100 and the second substrate 200.

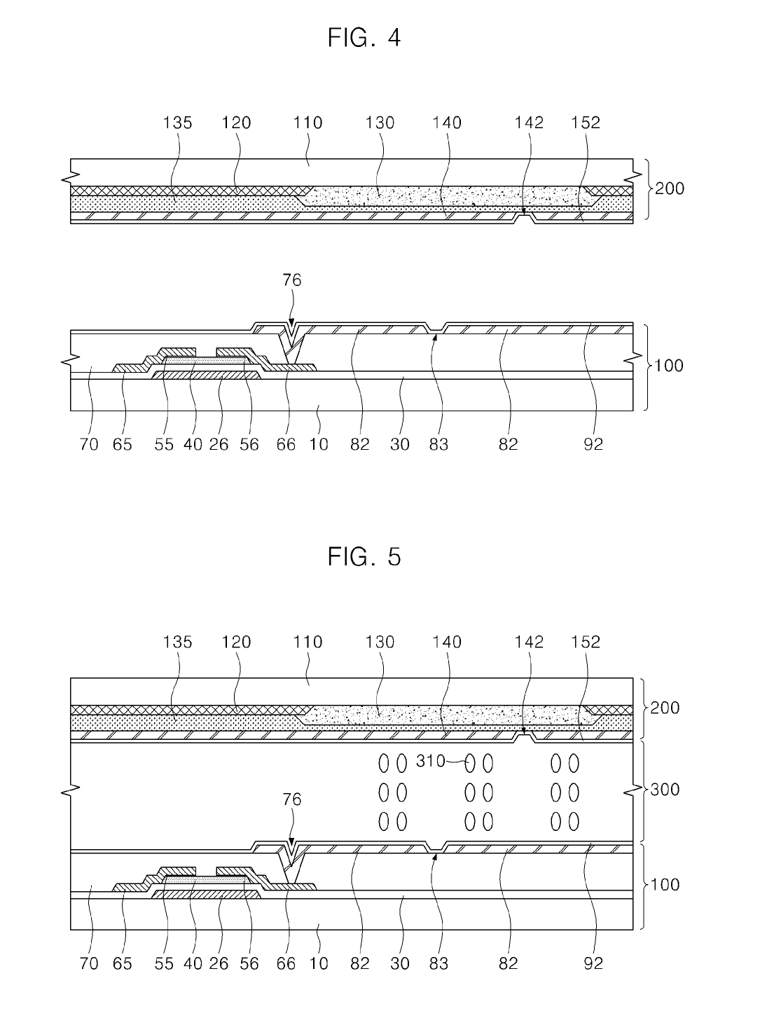

FIG. 3, FIG. 4, FIG. 5, and FIG. 6 are cross-sectional views showing a method of manufacturing an LCD device according to an exemplary embodiment of the present invention.

The pixel electrode 82, which includes the first domain forming unit 83 is disposed on the first substrate 100 (see FIG. 3).

To form the first substrate 100, a metal layer (not shown) for the gate wiring is formed on the first insulation substrate 10 using a sputtering method, and the metal layer is patterned to form the gate wiring, which includes the gate line 22, the gate electrode 26, and the storage electrode 28.

A gate insulation layer 30, which may be made of SiNₓ, is formed on the gate wiring. The gate insulation layer 30 may be formed by plasma enhance chemical vapor deposition (“PECVD”).

Hydrogenated amorphous silicon, polycrystalline silicon, or n+ hydrogenated amorphous silicon doped with high-density n-type impurities are sequentially deposited on the gate insulation layer 30 along with a conductive layer for wiring by a sputtering method, and then etched by a photolithography method to form the semiconductor layer 40, ohmic contact layers 55 and 56, and the data wiring including a data line 62, a source electrode 65, and a drain electrode 66.

The protective layer 70 is formed on the resultant structure, and the contact hole 76 is formed in the protective layer 70 to expose a portion of the drain electrode 66 using a reactive chemical vapor deposition.

A conductive material for the pixel electrode 82 is formed on the protective layer 70 using a sputtering method, and the conductive material layer is patterned to form the pixel electrode 82 including the first domain forming unit 83. The domain forming unit 83 may include protrusions or apertures. The horizontal distance W between the first domain forming unit 83 and the second domain forming unit 142 may be adjusted to be about 23 μm to about 70 μm.

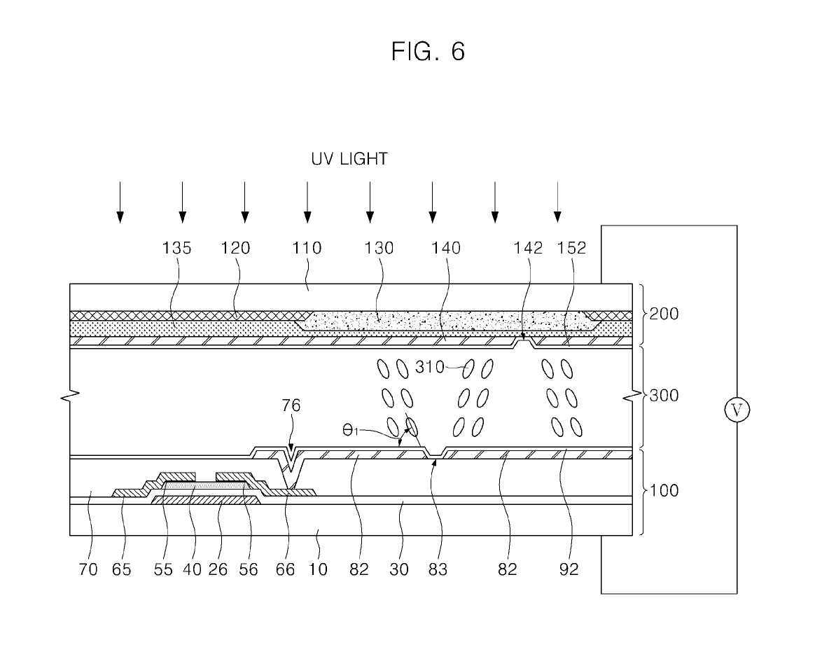

When the common electrode 140 does not include the second domain forming unit 142, a plurality of fine apertures 85 may be formed as the first domain forming unit 83 to form a plurality of fine electrodes 84, as shown in FIG. 7.

The first vertical alignment layer 92 may be formed by a printing method.

The second substrate 200 having a plurality of elements, such as the common electrode 140, formed thereon is arranged to face the first substrate 100 (see FIG. 4).

To form the second substrate 200, an opaque material, such as chrome (Cr), is deposited on the insulation substrate 110 and the opaque material layer is patterned to form the black matrix 120.

For example, photoresist is applied on the black matrix 120 and all exposed surfaces of the insulation substrate 110 to form a color filter layer, and the color filter layer is exposed to light and developed to form the red, green, and blue color filters 130. The overcoat layer 135 is formed on the black matrix 120 and the color filters 130.

The common electrode 140, which may be made of the transparent conductive material, is formed on the overcoat layer 135 using the sputtering method. The common electrode 140 may be patterned to form the second domain forming unit 142, and the patterning process may be omitted in a structure without the second domain forming unit 142.

The second vertical alignment layer 152 is formed on the common electrode 140 by a printing method. Then, spacers (not shown) may be spread on the second vertical alignment layer 152 to maintain a distance between the first substrate 100 and the second substrate 200, that is, “cell gap.”

The first substrate 100 and the second substrate 200 are attached to each other.

A sealant may be used to attach the first substrate 100 and the second substrate 200. The sealant is injected between the first substrate 100 and the second substrate 200 and cured to attach the first substrate 100 and the second substrate 200.

The space between the first substrate 100 and the second substrate 200 is filled with the LC mixture 300 (see FIG. 5).

The LC mixture 300 may include LC molecules 310, the UV-curable monomer, and the UV-curable initiator. The space between the first substrate 100 and the second substrate 200 is filled with the LC mixture 300 by a vacuum infiltration method. The LC molecules 310 may have negative dielectric constant anisotropy. For example, the LC molecules 310 may be nematic LC molecules. The UV-curable monomer may be an acrylate-based monomer and the UV-curable initiator may be made of a material that may absorb UV light, such as 2,2-dimethoxy-1, and 2-diphenyl ethanone.

Power for pre-tilting is applied to the first substrate 100 and the second substrate 200, and UV light is irradiated onto the first substrate 100 and the second substrate 200 to cure the LC mixture 300 (see FIG. 6).

After filling the space between the first substrate 100 and the second substrate 200 with the LC mixture 300, the power for pre-tilting is applied to the first substrate 100 and the second substrate 200. The power for pre-tilting may be applied through a pad for visual inspection of the first substrate 100 and the second substrate 200, or through a separate pad. The UV light is irradiated onto the first substrate 100 and the second substrate 200 to cure the LC mixture 300. In this case, a voltage of the power for pre-tilting may be maintained at about 2 V to about 10 V. The power for pre-tilting may use an alternating current or a direct current. Energy supplied to the LCD device UV irradiation may be adjusted to be about 2 J to about 36 J per unit area (cm²) of the pixel electrode 82. A wavelength of the UV light may be about 320 nm to about 380 nm. The conditions during UV irradiation may be adjusted according to the content of the UV-curable monomer. UV irradiation may be performed immediately after filling the space between the first substrate 100 and the second substrate 200 with the LC molecules 310, so the monomer is not cured before UV irradiation.

The LC molecules 310 are pre-tilted by curing the UV-curable monomer with UV irradiation while applying the power to the LCD device.

The random motion of the LC molecules 310 may be prevented by applying power to the LCD device, since the LC molecules 310 are pre-tilted toward the first domain forming unit 83 or the second domain forming unit 142. Accordingly, the speed at which black color is converted to white color may increase.

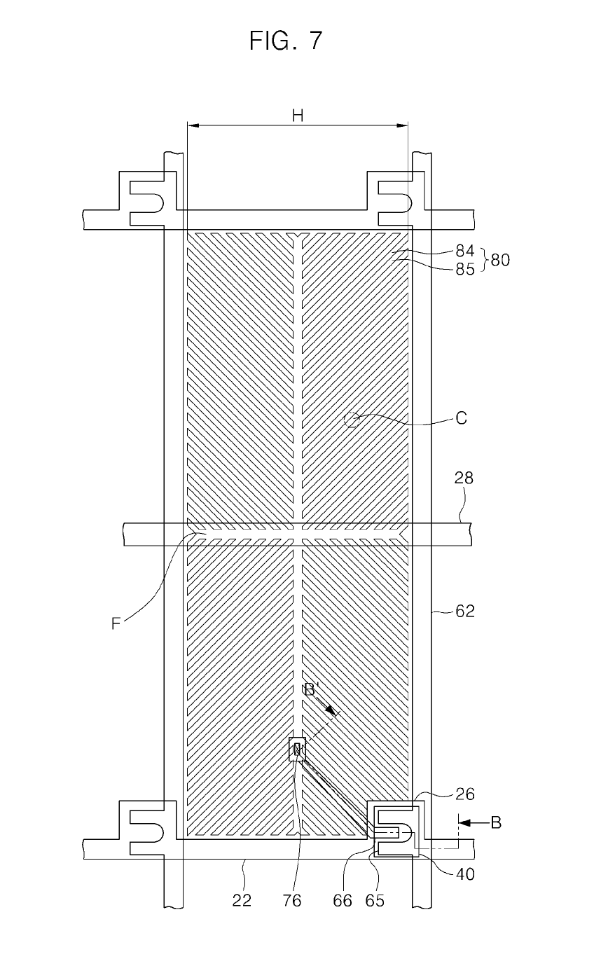

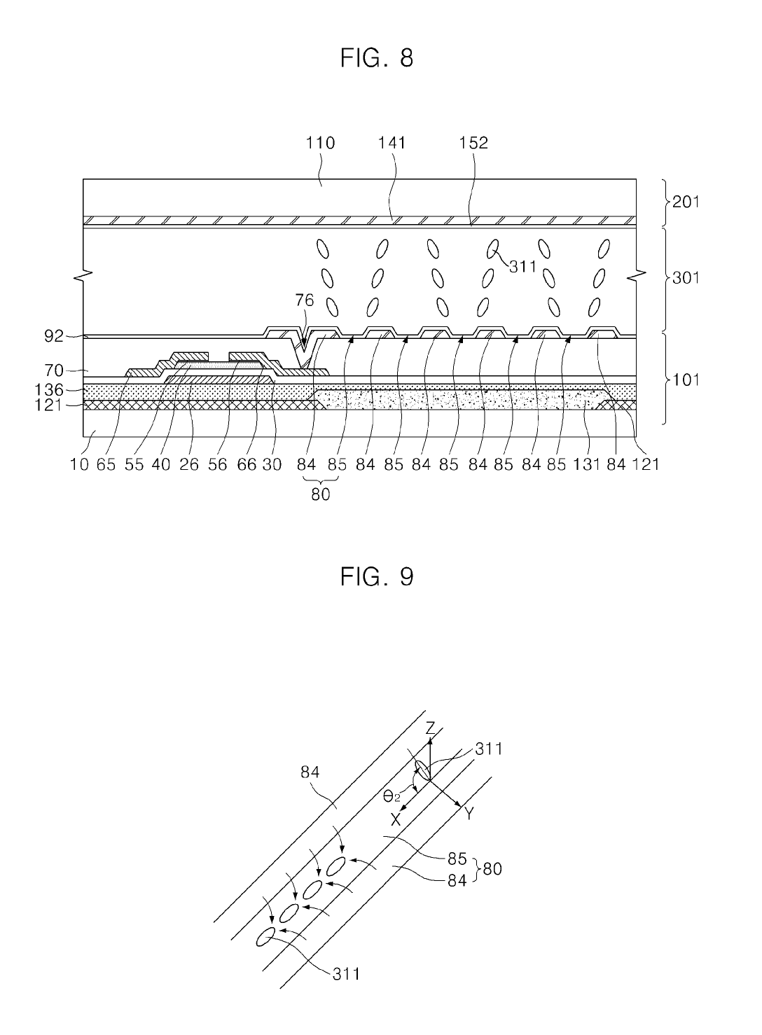

Although both the first domain forming unit 83 and the second domain forming unit 142 are included in the exemplary embodiment of FIG. 1, FIG. 2, FIG. 3, FIG. 4, FIG. 5, and FIG. 6, only a first domain forming unit is included in the exemplary embodiment of FIG. 7, FIG. 8, and FIG. 9.

FIG. 7 is a plan view showing an LCD device according to another exemplary embodiment of the present invention. FIG. 8 is a cross-sectional view taken along line B-B′ of FIG. 7. FIG. 9 is an enlarged view showing motion of LC molecules in portion C of FIG. 7. For convenience of description, the detailed description of elements that are the same as or similar to those of FIG. 1, FIG. 2, FIG. 3, FIG. 4, FIG. 5, and FIG. 6 will be omitted.

Referring to FIG. 7, FIG. 8, and FIG. 9, in an LCD device according to another exemplary embodiment of the present invention, both color filters 131 and a pixel electrode 80 are arranged on a first substrate 101. The LCD device may have an array on color filter (“AOC”) structure, in which a thin film transistor array, such as gate wiring, is disposed on the color filters 131, or a color filter on array (“COA”) structure, in which the color filters 131 are disposed on the thin film transistor array. Hereinafter, an LCD having the AOC structure will be described.

A black matrix 121 is disposed on an insulation substrate 10 of the first substrate 101. Red, green, blue color filters 131 are sequentially arranged in the pixel area between black matrixes 121. An overcoat layer 136 may be disposed on the color filters 131 to planarize surfaces of the black matrix 121 and the color filters 131.

Gate wiring, which includes a gate line 22, a gate electrode 26, and a storage electrode 28, a gate insulation layer 30, a semiconductor layer 40, ohmic contact layers 55 and 56, and data wiring, which includes a data line 62, a source electrode 65, and a drain electrode 66, are arranged on the over coating layer 136 like the exemplary embodiment of FIG. 1, FIG. 2, FIG. 3, FIG. 4, FIG. 5, and FIG. 6. A protective layer 70 with a contact hole 76 is disposed over the data wiring, and the pixel electrode 80 is arranged over the protective layer 70.

The pixel electrode 80 includes a plurality of fine electrodes 84 and a plurality of fine apertures 85 between the fine electrodes 84. More specifically, the pixel electrode 80 includes a main frame F with a cross shape to divide the pixel area into four areas. The fine electrodes 84 are arranged to be inclined to edges of the pixel area, and the fine apertures 85 are arranged between the inclined fine electrodes 84. The inclined fine electrodes 84 may be arranged at angles of about 45° with respect to a transmittance axis of a polarizer (not shown). The fine electrodes 84 extend from the center of the pixel area in four directions while being inclined at 45° with respect to the transmittance axis of the polarizer. Accordingly, when a driving voltage is applied to the LCD device, LC molecules 311 (see FIG. 8) become aligned in the four directions. The maximum length of the fine electrodes 84 may be less than a 0.5^{1/2} times the horizontal length H of the pixel electrode 80, according to the response time. In other words, the maximum length of the fine electrodes 84 may be less than a 0.5^{1/2} times the horizontal length H of the main frame F.

The first vertical alignment layer 92 is disposed over the pixel electrode 80 as in the exemplary embodiment of FIG. 1, FIG. 2, FIG. 3, FIG. 4, FIG. 5, and FIG. 6.

A second substrate 201 includes the insulation substrate 110 and a common electrode 141, which may be made of ITO, and faces the first substrate 101. Since the common electrode 141 does not include a domain forming unit, a process for patterning the common electrode 141 is not required. Therefore, the first substrate 101 and the second substrate 201 may be aligned when the first substrate 101 and the second substrate 201 are assembled. The transmittance of light may be improved and manufacturing costs may be reduced because an anti-static process is not required.

A second vertical alignment layer 152 is disposed on the common electrode 141 to vertically align the LC molecules 311. Spacers may be interposed between the first substrate 101 and the second substrate 201 to maintain the distance, i.e “cell gap”, between the first substrate 101 and the second substrate 201.

LC mixture 301 is injected between the first substrate 101 and the second substrate 201. The LC mixture 301 may be the same as LC mixture 300 of FIG. 1, FIG. 2, FIG. 3, FIG. 4, FIG. 5, and FIG. 6. Two-step motion and reverse direction domain may be restrained by pre-tilting the LC mixture 301 through UV irradiation, which may increase the response speed.

When an electric field is formed using only the fine electrodes 84 disposed on the first substrate 101, the LC molecules 311 may move in two step motions in which azimuthal rotation of the LC molecules 311 is performed parallel to fine apertures 85 arranged between the neighboring fine electrodes 84, after polar rotation of the LC molecules 311 is performed perpendicular to the fine electrodes 84. As a result, a reverse domain may be formed. However, in this exemplary embodiment of the present invention, one-step motion is performed by pre-tilting the LC molecules 311, so formation of the reverse domain may be prevented and the response speed may be improved. The pre-tilt angle θ₂ may be adjusted to about 88° to about 90°, more specifically, about 88.5° to about 90°. When presenting an X axis, which is parallel to the fine electrodes 84, a Y axis perpendicular to the fine electrodes 84, and a Z axis perpendicular to the X and Y axes, the molecules of LC molecules 311 may have a pre-tilt angle θ₂ in the X-Z plane with respect to the X axis.

The elements of the LCD device of FIG. 7, FIG. 8, and FIG. 9 are the same as those of FIG. 1, FIG. 2, FIG. 3, FIG. 4, FIG. 5, and FIG. 6, except for the positions of the black matrix 121 and the color filters 131, and the shapes of the pixel electrode 80 and the common electrode 141, and thus duplicated descriptions of the same elements will be omitted.

### Example

A response speed between gray levels was measured while a rotational viscosity of the LC molecules 311 and the cell gap were changed. In Table 1, Comparative Examples 1 and 2 were driven at 60 Hz and Comparative Example 3 and Example 1 were driven at 120 Hz.

TABLE 1

| | Comparative | Comparative | Comparative | |
|---|---|---|---|---|
| | Example 1 | Example 2 | Example 3 | Example 1 |
| Rotational | 133 | 133 | 133 | 117 |
| Viscosity | | | | |
| (mPa · s) | | | | |
| Cell Gap | 3.95 | 3.55 | 3.95 | 3.55 |
| (μm) | | | | |

The response speeds between gray levels were 8.06 ms, 7.08 ms, 9.11 ms, and 4.87 ms in Comparative Example 1, Comparative Example 2, Comparative Example 3, and Example 1, respectively.

As shown by Comparative Examples 1 and 2, the response speed increases by about 1 ms when the rotational viscosity is maintained and the cell gap is decreased by 0.4 μm to 3.55 μm. The response speed may be increased due to an increase in falling time.

As shown by Comparative Examples 1 and 3, the response speed increases by about 1 ms when the rotational viscosity is maintained and the driving frequency is increased from 60 Hz to 120 Hz.

As shown by Comparative Example 1 and Example 1, the response speed decreases by about 3.2 ms when the rotational viscosity and the cell gap are decreased to 117 mPa·s and 3.55 μm, respectively, and the driving frequency is increased from 60 Hz to 120 Hz. The response speed may increase because due to an increase in falling time. When a driving frequency of 120 Hz is employed, movie visibility may be increased because the response time may be improved.

According to exemplary embodiments of the present invention, the response speed of the LC molecules may be improved and design margins of the pixel electrode and the common electrode are obtained, which may improve the light transmittance of the LCD device.

In particular, visibility deteriorations, such as a ghost phenomenon, caused by a slow falling time of the LC molecules may be resolved by improving the falling time of the LC molecules.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A liquid crystal display device, comprising:
a first substrate comprising a pixel electrode, which comprises a first domain forming unit, and a first vertical alignment layer arranged on the pixel electrode;
a second substrate facing the first substrate and comprising a common electrode and a second vertical alignment layer arranged on the common electrode; and
a liquid crystal mixture interposed between the first substrate and the second substrate, the liquid crystal mixture comprising liquid crystal molecules, an ultraviolet-curable monomer, and an ultraviolet-curable initiator,
wherein a distance between the first substrate and the second substrate is 3.6 μm or less, and
a rotational viscosity of the liquid crystal mixture is 130 mPa·s or less.

2. The liquid crystal display device of claim 1, wherein the first domain forming unit comprises apertures or protrusions.

3. The liquid crystal display device of claim 2, wherein the pixel electrode comprises a plurality of fine electrodes divided by the apertures.

4. The liquid crystal display device of claim 1, wherein the common electrode comprises a second domain forming unit.

5. The liquid crystal display device of claim 4, wherein the second domain forming unit comprises apertures or protrusions.

6. The liquid crystal display device of claim 1, wherein the liquid crystal mixture has a refractive index anisotropy of about 0.085 to about 0.15.

7. The liquid crystal display device of claim 1, wherein the liquid crystal mixture comprises low viscosity liquid crystal molecules.

8. The liquid crystal display device of claim 1, wherein a content of the ultraviolet-curable monomer of the liquid crystal mixture is over 0% by weight and less than or equal to 10% by weight, based on the liquid crystal molecules.

9. The liquid crystal display device of claim 1, wherein a content of the ultraviolet-curable initiator of the liquid crystal mixture is over 0.025% by weight and less than or equal to 0.05% by weight, based on the liquid crystal molecules.

10. The liquid crystal display device of claim 1, wherein the driving frequency of the liquid crystal display device is 120 Hz.

11. A method of manufacturing a liquid crystal display device comprising:
forming a first substrate, the first substrate comprising a pixel electrode, which comprises a first domain forming unit, and a first vertical alignment layer arranged on the pixel electrode;
forming a second substrate, the second substrate facing the first substrate and comprising a common electrode and a second vertical alignment layer arranged on the common electrode;
coupling the first substrate and the second substrate together with a distance therebetween;
interposing a liquid crystal mixture between the first substrate and the second substrate, the liquid crystal mixture comprising liquid crystal molecules, an ultraviolet-curable monomer, and an ultraviolet curable initiator and having rotational viscosity of 130 mPa·s or less; and
curing the liquid crystal mixture by applying power for pre-tilting to the first substrate and the second substrate and irradiating ultraviolet rays onto the first substrate and the second substrate.

12. The method of claim 11, wherein the distance between the first substrate and the second substrate is 3.6 μm or less.

13. The method of claim 1 1, wherein the liquid crystal mixture has a refractive index anisotropy of about 0.085 to about 0.15.

14. The method of claim 1 1, wherein rotational viscosity of the liquid crystal mixture is adjusted using low viscosity liquid crystal molecules.

15. The method of claim 11, wherein the power for pre-tilting is adjusted to be about 2 V to about 10 V.
